(19) United States
(12) Patent Application Publication
(10) Pub. No.: US 2003/0176817 A1
(43) Pub. Date: Sep. 18, 2003

(54) Electrical multi-functional fitness and body slimming massage device

(76) Inventor: Shun-Yi Chang, Taichung (TW)

Correspondence Address: Shun-Yi CHANG, P.O. Box No. 6-57, Chung-Ho, Taipei, 235, TW

(21) Appl. No.: 10/383,760

(22) Filed: Mar. 10, 2003

(30) Foreign Application Priority Data
Mar. 12, 2002 (TW) 091202834

(51) Int. Cl. A61H 7/00

(52) U.S. Cl. 601/9

(57) ABSTRACT

An electrical multi-functional fitness and body slimming massage device, particularly to functions relative to breast enhancement/skin care massage device, fitness/body slimming massage belt and electrical cupping developed on the basis of the air suction/release principle. The present invention has a housing and a plurality of suction cups with various sizes is disposed at the front end of the housing. Each suction cup has an air hole corresponding to air hole of the housing, with hoses disposed inside an air chamber. A gear/cam control box is disposed in the air chamber. One of the hoses connects to the cam structure, which presses and releases the hose to form a turbulent flow and control the suction/release in a fixed rhythm. A control valve is disposed outside the housing, with which the user can select suction only or release only function.

### BACKGROUND OF THE INVENTION

(a) Field of the Invention

The present invention relates to an electrical multi-functional fitness and body slimming massage device, particularly to functions of breast enhancement/skin care massage device, fitness/body slimming massage belt and electrical cupping glass developed on the basis of the air suction/release principle.

(b) Description of the Prior Art

The technology developed on the basis of air suction/release principle is currently applied only to big instruments, such as breast enhancement and skin care massage device, used for professional beauty salons. The conventional structure mainly includes an air chamber to suck the air directly, moreover, an electronic air valve is used in controlling open and close of the air valve while an IC program is in controlling the speed of the suction/release. To make use of the kind of conventional equipments or instruments, much electrical current and power are required. Since most of the functions are controlled by electronic components, the cost is about 5 to 10 times expensive than the present invention. Besides, such equipments or instruments are used to be big and heavy in size, so they are usually installed in beauty salons and thus consumers must spend time and money to enjoy breast enhancement and skin care massage there.

One existing device directed to a kind of cheaper breast enhancement device available in the market which includes (1) several big suction cups; (2) a hose connecting to the suction cups; and (3) a suction ball connecting to the hose. This structure is very common and has not been changed a lot till now. In fact, both manual and electrical breast enhancement and skin care massage device have shortcomings that must be improved. The prior art manual breast enhancement and skin care massage device uses suction balls to provide the suction, but the strength of suction is weak and cannot be adjusted, besides, which must be operated by a third party to provide services. Such breast enhancement and skin care massage device has many hoses, which cannot be operated easily and must be removed for the replacement of the suction cups.

The other existing device directed to a kind of message belt available in the market used for hands, feet, waist, face and neck is provided with an air bag. An electrical air compressor is used to pump the air into the air bag and an electronic air valve is used to control the charge and exhaustion of the air, thereby enabling the air bag to perform massage by pressing and relaxing user's body. However, in case an inappropriate control of the air valve by filling the air to the air bag continuously and pressing the contact part thereof may cause damages to the air bag or user's body.

Moreover, Another existing device directed to a kind of cupping glasses for Chinese traditional medical treatment available in the market is used manually and the practitioner must suck the air out of the cup frequently with hands. When there are many patients waiting for treatment, using the cupping glass too often may cause arthritis of the practitioner's hands.

In order to improve the shortcomings of the aforesaid conventional devices, the inventor of the present invention, following long-term diligent researches and experiments, finally culminated in the development and design of the present invention of an electrical multi-functional body slimming and massage device.

### SUMMARY OF THE INVENTION

The primary objective of present invention is to provide an electrical multi-functional fitness and body slimming massage device combining various functions of breast enhancement/skin care massage device/body slimming massage belt and electrical cupping glass developed on the basis of the air suction/release principle. The present invention is easy to use, chargeable, thin and light without redundant hoses. An improved air chamber is capable to increase the suction, and the massage function is controlled appropriately by the suction/release effect controlled by a cam mechanism. The suction cups can be separated from the housing for easy operation. Since the present invention is a mechanical device without many electronic components, the price is reasonable and the weight is light, very suitable for private and personal use.

The present invention is applicable to a fitness/body slimming massage belts. Unlike the prior art fitness/body slimming device producing massage effect on the basis of the air bag pressure principle, the present invention produces a kneading effect by using the suction/release effect of a plurality of small suction cups.

The present invention is also applicable to an electrical cupping glass for Chinese traditional medical treatment. A rapid joint is designed for the cupping glass for easy replacement of suction cups with difference sizes. With the charging device, the cupping glass is operated easily, conveniently, simply and durably.

To achieve the aforementioned objectives, the present invention provides (1) an improved air chamber structure, especially an improved non-piston diaphragm cylinder comprising a housing. The housing has each one air inlet and outlet and each one diaphragm is disposed above the inlet and outlet, respectively, to control the operations thereof. A fixed plate is disposed above the diaphragm and an air hole below the fixed plate extends to the air chamber. A row hole leads the air to the outlet. The air chamber is disposed above the fixed plate and joints to a Diaphragm air pump to control the intake and exhaustion of the airflow in the air chamber. The Diaphragm air pump joints to an eccentric shaft, which is driven by a motor and produces a rapid suction and exhaustion effect under the rapid rotation of the motor. Unlike the flat air chamber usually used for the prior art breast enhancement/skin care massage belt, the present invention has an additional wall disposed on the fixed plate and within the range of the Diaphragm air pump. With this design, the air chamber forms a cylinder wall similar to the piston air pump to increase the suction of the air chamber up to a level between the ordinary flat diaphragm cylinder and piston cylinder. The suction of the improved air chamber structure is higher than the suction of the ordinary flat diaphragm cylinder by 20-30%.

To achieve the aforementioned objective, the present invention provides (2) a suction/release effect produced during the suction of the air chamber on the basis of the cam principle. In the present invention, the aforementioned air chamber, including the diaphragm cylinder and piston cylinder is used, and the column of the conventional eccentric wheel is replaced with a turbine, the front end of which joints to the eccentric shaft to form a turbine eccentric shaft. When the motor rotates rapidly, the turbine eccentric shaft drives the diaphragm and the gear simultaneously and the latter, in turn, drives the cam and a pressure plate. A housing of the air pump is disposed against the pressure plate and a hose is fixed between the inner wall of the housing and the pressure plate. When the cam presses the pressure plate, the pressure plate presses and locks the hose very rapidly. When the cam releases from the pressure plate, the pressure plate springs away from the hose under the elasticity thereof to unblock the airflow. The press/release action is capable to provide the function of the electronic air valve. This technology is also applicable to an air valve of a mechanical air valve and the speed of the airflow or water flow is controlled with an inverter motor in this case.

To achieve the aforementioned objective, the present invention provides (3) an additional spring in the hose to avoid deformation. This improvement is made to eliminate the shortcomings of the hose that are frequently found in the products, especially small products, available in the market, and ensure that the hose will not deform or bend to block the airflow due to suction in a small space. The additional spring added in the hose is capable not only to control the deformation, but also to improve the assembly efficiency.

To achieve the aforementioned objective, the present invention provides (4) a device used to change a suction cup rapidly. The device has a suction cup. Two protruded points are disposed on a joint neck of the air hole of the suction cup. A butterfly valve-like part is disposed below the protruded points and an O-ring is installed at the front end thereof to form an airtight structure when the suction cup and the housing joint. A joint ring is disposed at the contact point of the suction cup and the housing and fixed tightly to the housing. Two butterfly valve-like parts with each one indentation are disposed on the joint ring. When the suction cup and the housing joint, the two butterfly valve-like parts articulate rapidly, forcing the O-ring to form the airtight structure. The indentations and the protruded points position themselves rapidly in this process to avoid dropping.

To achieve the aforementioned objectives, the present invention provides (5) an integrated technology applicable to the breast enhancement/skin care massage device, fitness/body slimming massage belt and electrical cupping glass. The aforementioned technology plus a safety design forms the basis of the simple, light, convenient, safe, popular and effective breast enhancement/skin care massage device, fitness/body slimming massage belt and electrical cupping glass.

To enable a further understanding of the said objectives and the technological methods of the invention herein, the brief description of the drawings below is followed by the detailed description of the preferred embodiments.

### BRIEF DESCTIPTION OF THE DRAWINGS

FIG. 1 and FIG. 2 are cross-sectional views in comparison between an improved air chamber having a wall and a conventional flat air chamber;

FIG. 3 is an exploded view of the improved air chamber of the present invention;

FIG. 4 and FIG. 5 are cross-sectional and perspective exploded views showing the massage effect produced by the air chamber during the suction on the basis of the cam principle according to the present invention;

FIG. 6 and FIG. 7 are cross-sectional and perspective exploded views showing a spring added to the hose to avoid deformation according to the present invention;

FIG. 8 and FIG. 9 are cross-sectional and perspective exploded views showing a suction cup is being assembled/dissembled according to the present invention;

FIG. 10 and FIG. 11 are cross-sectional and perspective exploded views showing the embodiment of an integrated technology to a breast enhancement/skin care massage belt according to the present invention;

FIG. 12 and FIG. 13 are side and top sectional planar views showing the other embodiment of an integrated technology to a fitness/body slimming massage belt according to the present invention;

FIGS. 14 and 15 are cross-sectional and perspective exploded views showing another embodiment of an integrated technology to an electrical cupping glass according to the present invention.

### DETAILED DESCRIPTION OF THE PREFERRED EMBODIMENT

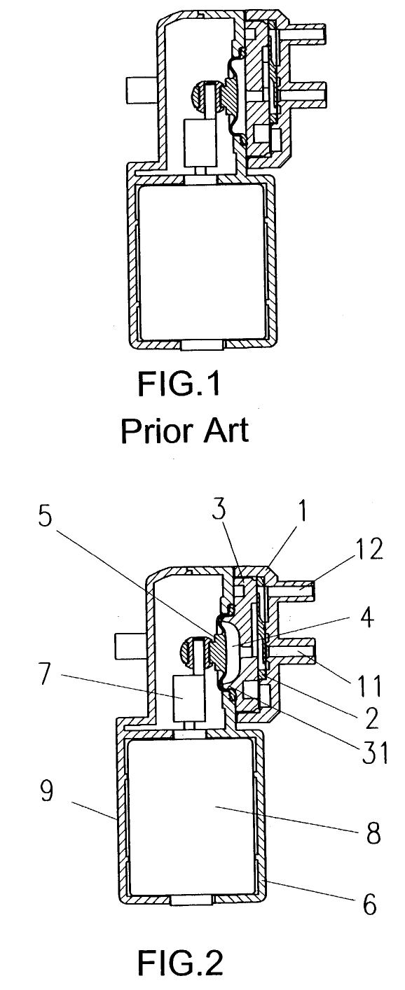

As shown in FIGS. 1 and 2, the present invention provides an improved air chamber structure, especially an improved non-piston diaphragm cylinder comprising a housing 1. The housing 1 has each one air inlet 11 and air outlet 12 and each one diaphragm 2 is disposed above the inlet 11 and the outlet 12, respectively, to control the operations thereof. A fixed plate 3 is disposed above the diaphragm 2 and an air hole below the fixed plate 3 extends to the air chamber 4. A row hole 32 leads the air to the outlet 12. The air chamber 4 is disposed above the fixed plate 3 and joints to a Diaphragm air pump 5 with the housing 1 and an upper cover 6 thereof to form a fixed diaphragm cylinder. The Diaphragm air pump 5 joints to an eccentric shaft 7, which is attached fixedly to and driven by a motor 8. A rapid suction and exhaustion effect is produced by the up-and-down motion of the Diaphragm air pump 5 driven by the eccentric shaft 7 under the rapid rotation of the motor 8. Unlike the flat air chamber usually used for the prior art breast enhancement/skin care massage belt, the present invention has an additional wall 31 disposed on the fixed plate 3 and within the range of the Diaphragm air pump 5. With this design, the air chamber 4 forms a cylinder wall similar to the piston air pump to increase the suction of the air chamber up to a level between the ordinary flat diaphragm cylinder and piston cylinder. The suction of the improved air chamber structure is higher than the suction of the ordinary flat diaphragm cylinder by 20-30%.

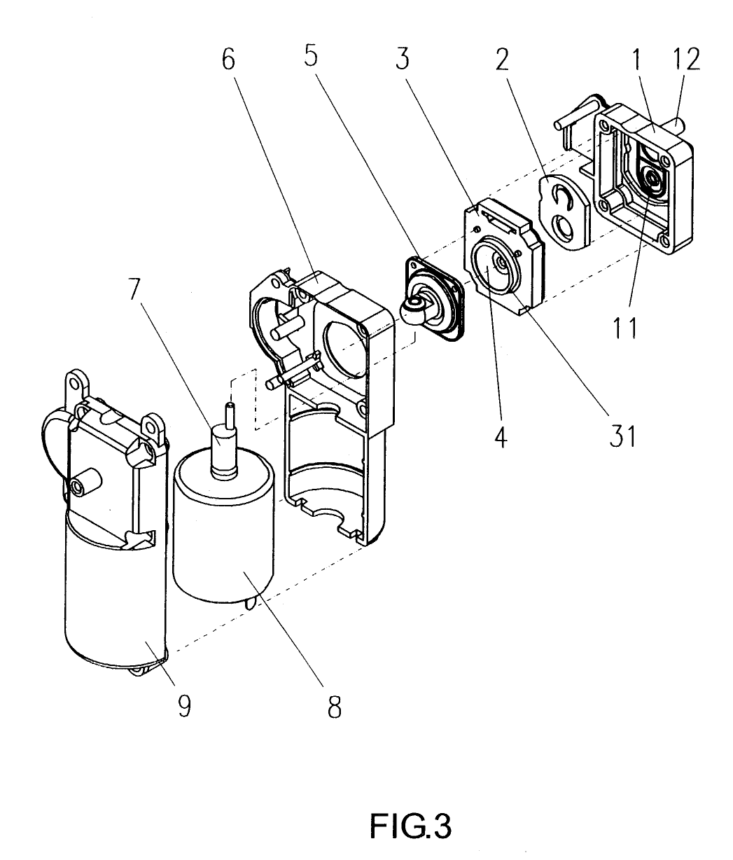

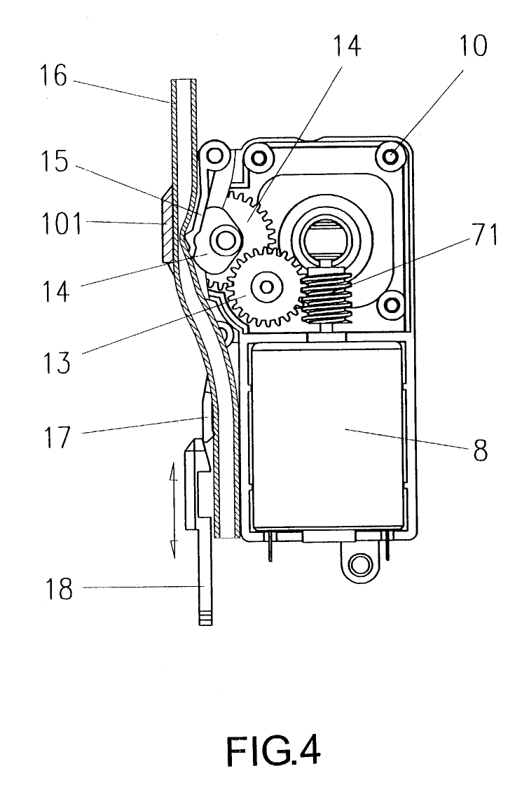

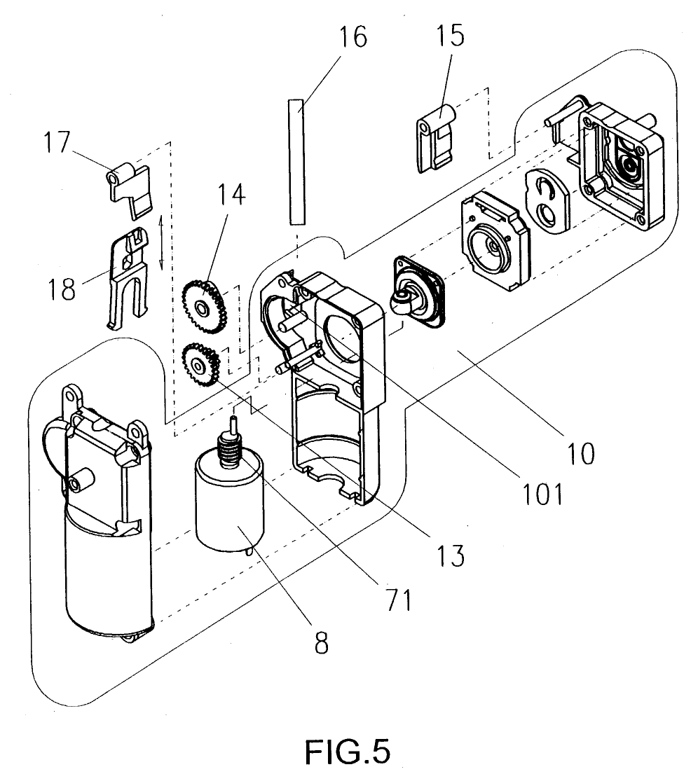

As shown in FIGS. 3 and 4, the present invention has a diaphragm or piston cylinder block 1. In the present invention, the column of the conventional eccentric wheel is replaced with a turbine, the front end of which joints to the eccentric shaft to form a turbine eccentric shaft 3. When the motor 2 rotate rapidly, the turbine eccentric shaft 3 drives the diaphragm or the piston and the gear 4 simultaneously and the latter, in turn, drives the cam 5 and a pressure plate 6. A housing of the air pump is disposed against the pressure plate 6 and a hose 7 is fixed between the inner wall of the housing and the pressure plate 6. the other end of the hose 7 is connected to the air inlet of the diaphragm or piston cylinder block 1 as shown in FIGS. 1-3. When the cam 5 presses the pressure plate 6, the pressure plate 6 presses and blocks the hose 7 very rapidly. When the cam 5 releases the pressure plate 6, the pressure plate 6 springs away from the hose 7 under the elasticity thereof to unblock the airflow. The press/release action is capable to provide the function of the electronic air valve. This technology is also applicable to an air valve of a mechanical air valve and the speed of the airflow or water flow is controlled with an inverter motor in this case.

A manual air/water low control switch is installed outside of the housing. When a suction control lock 9 pushes forward, its incline forces a suction control plate 8 to press and deform the hose 7 very rapidly and, thus, block the airflow. When the suction control lock 9 pushes downward, the suction control plate 8 springs away from the hose 7 under the elasticity thereof to unblock the airflow.

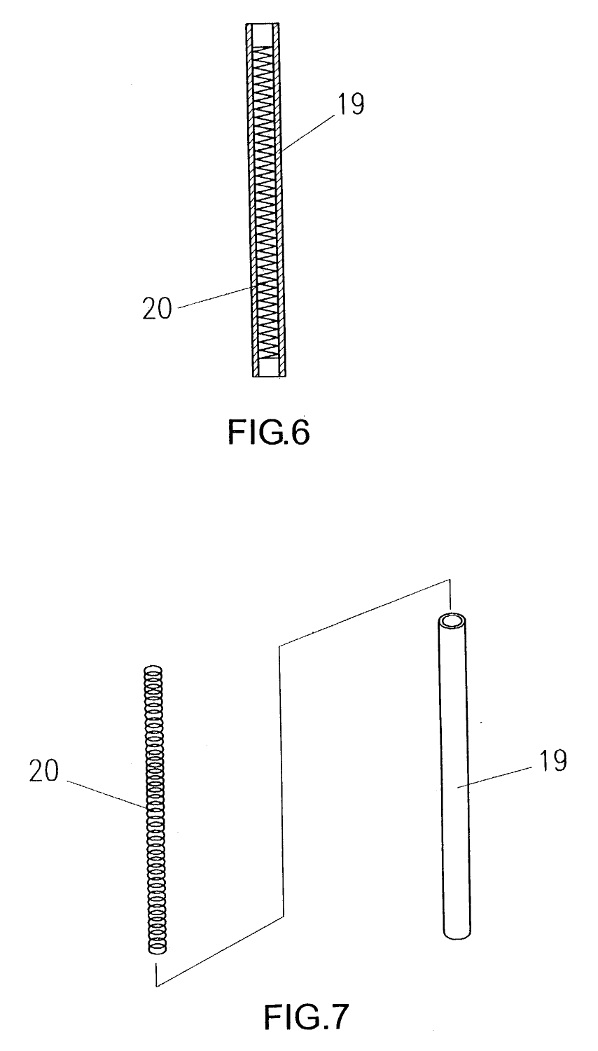

As shown in FIGS. 6 and 7, the present invention provides an additional spring 20 in the a flexible hose 19 to avoid deformation. This improvement is made to eliminate the shortcomings of the hose that are frequently found in the products, especially small products, available in the market, and ensures that the hose will not deform or bend to block the airflow due to suction in a small space. The additional spring 20 added in the hose 19 is capable not only to control the deformation, but also to improve the efficiency of the assembly.

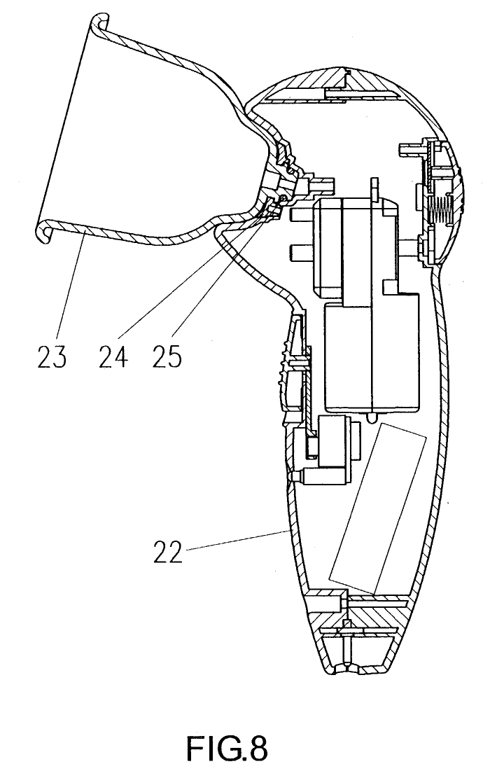

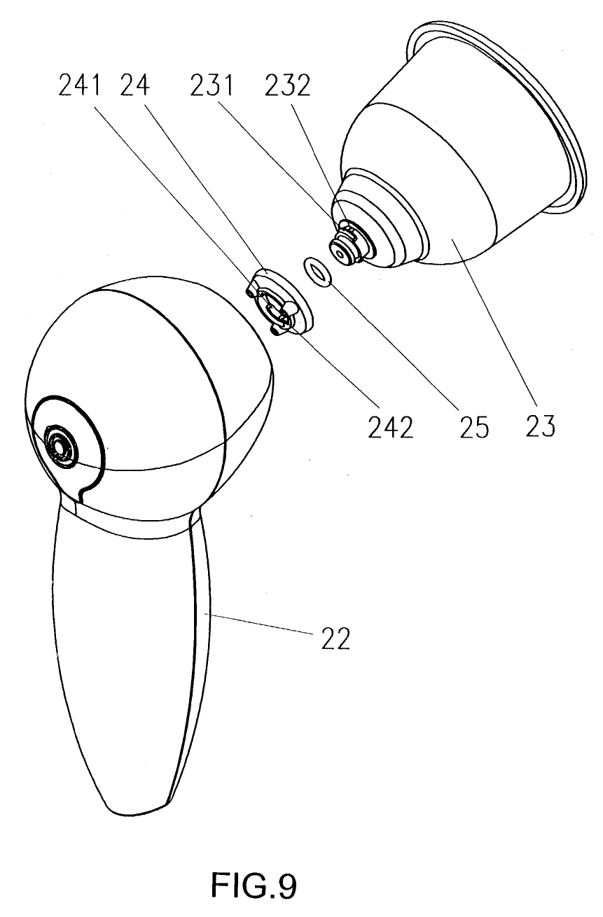

As shown in FIGS. 8 and 9, the present invention has a housing 22 as the main suction device and a suction cup 23. Two protruded points 232 are disposed on a joint neck of the air hole of the suction cup 23. A butterfly valve-like part 231 is disposed below the protruded points 232 and an O-ring 25 is installed at the front end thereof to form an airtight structure when the suction cup 23 and the housing 22 joint. A rapid joint ring 24 is disposed at the contact point of the suction cup 23 and the housing 22 and fixed tightly to the housing 22. Two butterfly valve-like parts 241 with each one indentation 242 are disposed on the rapid joint ring 24. When the suction cup 23 and the housing 22 joint, the two butterfly valve-like parts 231, 241 articulate rapidly, forcing the O-ring 25 to form the airtight structure. The indentations 242 and the protruded points 232 position themselves rapidly in this process to avoid dropping.

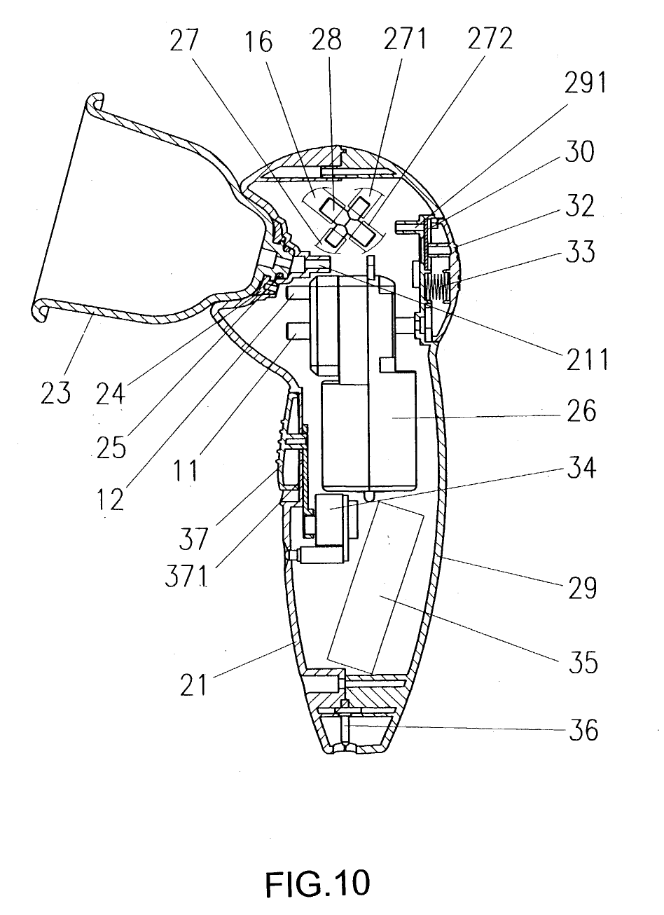

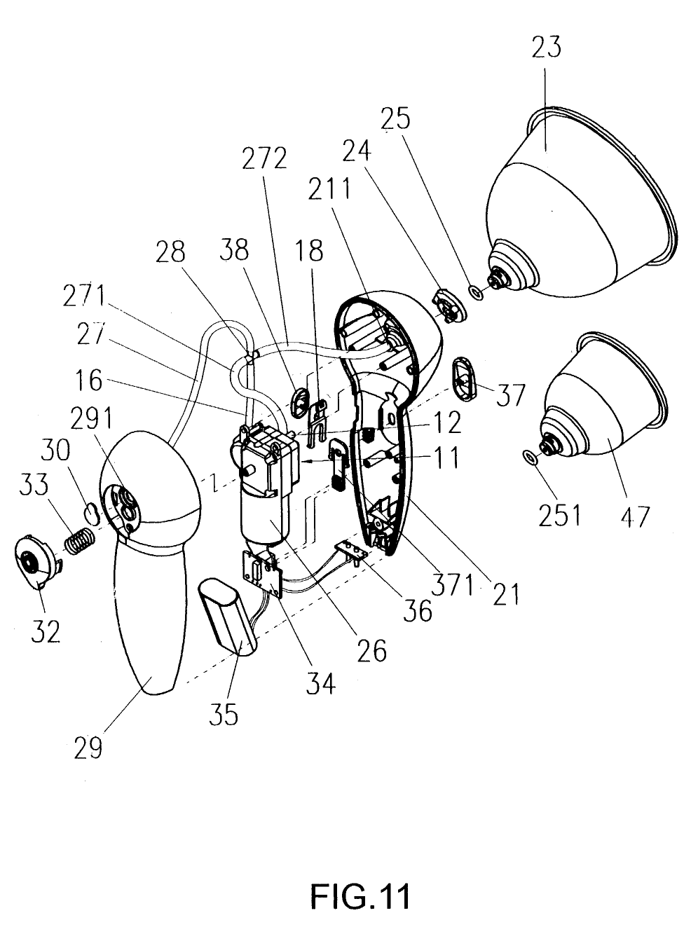

As shown in FIG. 10 and 11, the present invention has a diaphragm or piston cylinder block 1 that provides the required suction. The suction produced by the diaphragm or piston cylinder block 1 is transmitted through the air inlet 11, a hose 272, and a universal joint 28 to a hose 271. The hose 271 connects to a air hole 21 of an upper cover 29 of the housing and a rapid joint ring 24 fixed tightly to the upper cover 29, so that a suction cup 23 is capable to connect to the upper cover 29 of the housing rapidly and tightly through an O-ring 25. The press/release of the hose 27 on the universal joint 28 is controlled by a cam in the diaphragm or piston cylinder block 26, as shown in FIGS. 34 and 35 to provide a massage effect. The massage effect of the hose 27 can also be controlled by a suction control lock 18. When an external suction control push button 17 pushes forward to the forefront, the massage effect is stopped by the interlocked suction control lock 18 to fill the suction to its highest level. This is the enhanced function of the present invention.

In addition to the perfect suction effect, the present invention also provides a safety design. A hose 16 on the universal joint 28 is connected to an air hole 291 of the lower cover 211 of the housing, which extends upward and connect tightly to an emergency exhaustion diaphragm 30. When the suction is too high, the emergency exhaustion diaphragm 30 can be opened by pressing an emergency exhaustion switch 32 to let outside airflow in the suction cup 23 to release the suction in the suction cup 23. When the emergency exhaustion switch 32 is released, a spring 33 springs the emergency exhaustion switch 32 back to its original position and the emergency exhaustion diaphragm 30 closes the air inlet 291 of the lower cover of the housing to re-fill the suction.

The present invention also provides a charging function. A battery 35 provides the power for the motor of the diaphragm or piston cylinder block 26. When the power of the battery 35 is low, connect a charging control plate 36 to a power converter. The charging control plate 36 further connects to a circuit plate 34 and the battery 35 is charged through the charging components of the circuit plate 34.

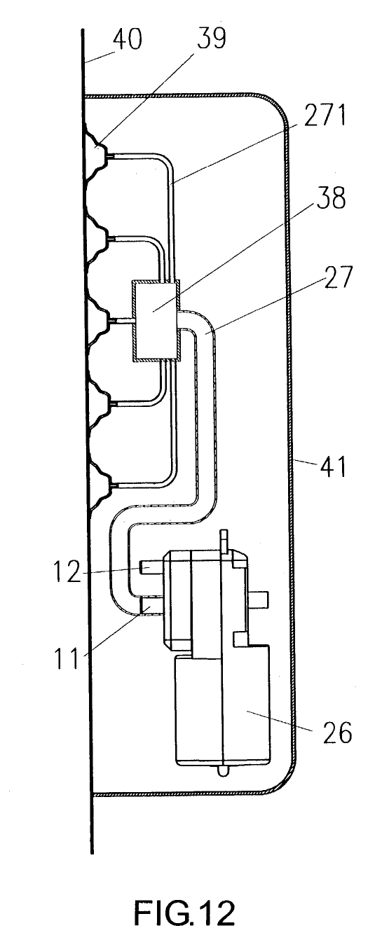

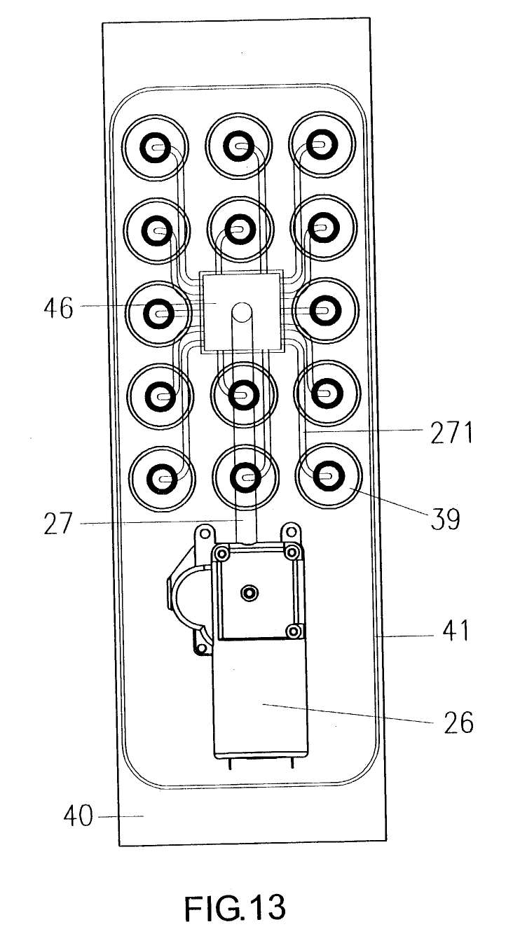

As shown in FIGS. 12 and 13, the present invention has a diaphragm or piston cylinder block 26 that provides the required suction. The suction provided by the diaphragm or piston cylinder block 26 is transmitted through the air inlet, as shown in FIGS. 1 and 2, a hose 27 to a central air chamber 38. The air of all suction cups 39 is gathered to the central air chamber 38 through the hose 27. When the diaphragm or piston cylinder block 26 operates on the basis of the cam principle of the present invention, as shown in FIGS. 3 and 39, a kneading effect is produced. All the parts and components are protected appropriately by fixing a housing 41 on a waist belt 40 to commercial value for manufacturers.

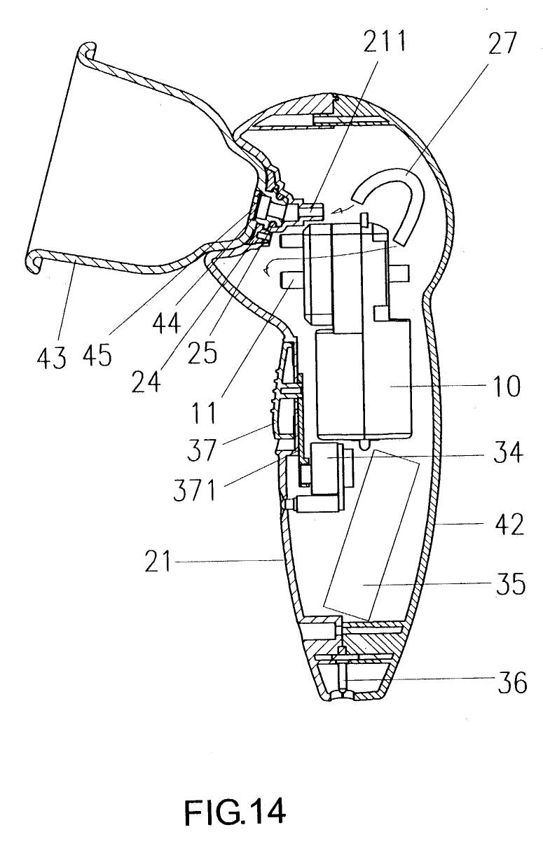

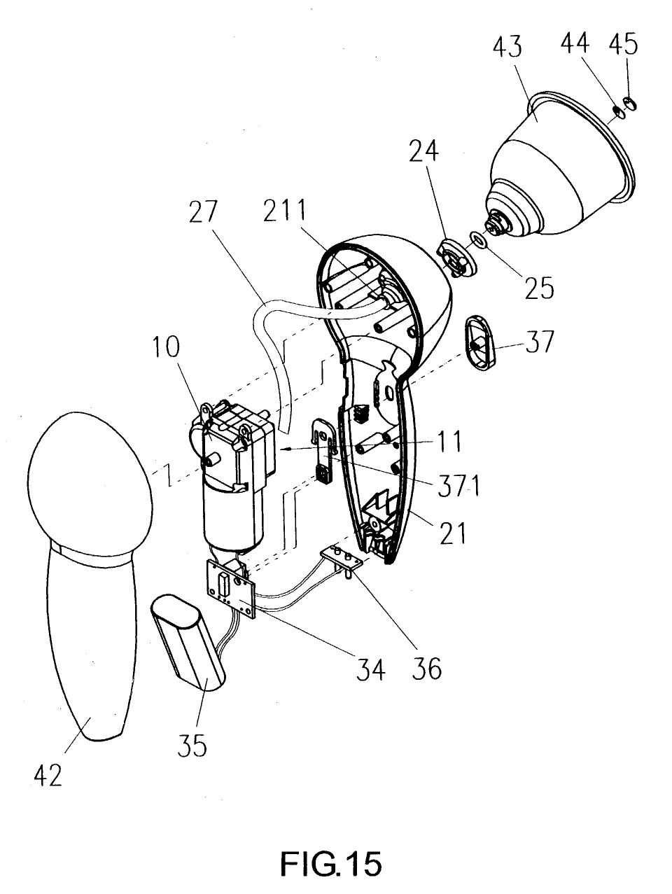

As shown in FIGS. 14 and 15, the present invention has a diaphragm or piston cylinder block, as shown in FIGS. 1 and 3, that provides the required suction. In the rapid suction cup replacement design, as shown in FIGS. 7 and 8, a rapid joint ring 24 is fixed to the housing 21 and every suction cup has an O-ring 25 to provide required airtight function for the rapid suction cup replacement.

The present invention also provides a leakage prevention function. A sealing diaphragm 45 is disposed at the air hole of the suction cup 43. A sealing diaphragm fixed ring 44 of the sealing diaphragm 45 is firmly fixed to the suction cup 43. During the suction, the sealing diaphragm 45 opens the air hole to release the air in the suction cup 43. When the housing 21 and the suction cup 43 separate from each other rapidly, the sealing diaphragm 45 is sucked instantly and tightly due to the suction in the suction cup 43, producing a cupping effect.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. An electrical multi-functional fitness and body slimming massage device having a non-piston diaphragm cylinder comprising:
an air chamber, a plurality of hoses, and a suction cup, said air chamber having a cam, a soft hose, a motor, an air inlet and outlet, each diaphragm being disposed on the above said inlet and outlet, respectively, to control operations thereof; a fixed plate being disposed above said diaphragm and an air hole formed below said fixed plate extending to the air chamber, a row hole leading air to said outlet, the air chamber being disposed above said fixed plate and jointing to a diaphragm air pump to control air intake and exhaustion of the air chamber, said diaphragm air pump jointing directly to a motor and producing a rapid suction and exhaustion effect under the rapid rotation of a motor; an additional wall being disposed on said fixed plate and within the range of said diaphragm air pump, the air chamber forming a cylinder wall similar to a piston air pump to increase suction of the air chamber.

2. An electrical multi-functional fitness and body slimming massage device according to claim 1, a suction and release effect produced during suction of the air chamber on the basis of the cam principle, the air chamber being used and a column of an eccentric wheel being replaced with a turbine, a front end of which joints to a eccentric shaft to form a turbine eccentric shaft; when the motor rotates rapidly, said turbine eccentric shaft driving said diaphragm and a gear simultaneously, and the gear, in turn, driving a cam and a pressure plate, a housing of the air pump being disposed against said pressure plate and a hose being fixed between an inner wall of the housing and the pressure plate; when the cam presses the pressure plate, the pressure plate pressing and locking said hose very rapidly; when the cam releases from the pressure plate, the pressure plate springing away from said hose under the elasticity thereof to unblock the airflow; the press/release action being capable to provide a function of a electronic air valve.

3. An electrical multi-functional fitness and body slimming massage device according to claim 1, wherein two protruded points being disposed on a joint neck of a air hole of said suction cup, a butterfly valve-like part being disposed below said protruded points and an O-ring being installed at a front end thereof to form an airtight structure when said suction cup is being jointed to the housing; a joint ring being disposed at a contact point of said suction cup and the housing; two butterfly valve-like parts with each one indentation being disposed on said joint ring; when said suction cup being jointed to the housing, the two butterfly valve-like parts articulating rapidly thereby forcing said O-ring to form the airtight structure; said indentations and said protruded points positioning to each other rapidly in this process to avoid dropping.

4. An electrical multi-functional fitness and body slimming massage device according to claim 1, wherein the air chamber and the suction cup are in connection with a plurality of spring being capable of avoiding deformation.

5. An electrical multi-functional fitness and body slimming massage device according to claim 1, wherein the motor are connected with two rechargeable batteries and charging circuits.

6. An electric multi-functional fitness/body slimming massage device according to claim 1, wherein, a plurality of suction cups is gathered and connected to the central air chamber through the hoses.

7. An electrical multi-functional fitness and body slimming device according to claim 1 wherein, the housing is disposed with a rapid joint ring having an O-ring provided therein and further jointing to the suction cup thereby enabling airtight effect; a sealing diaphragm with a sealing diaphragm fixed ring are disposed at the air hole inside the suction cup thereby enabling leakage prevention.
